(19) United States
(12) Patent Application Publication
(10) Pub. No.: US 2003/0199610 A1
(43) Pub. Date: Oct. 23, 2003

(54) Pigmented jet inks

(76) Inventor: Richard M. Podhajny, Collegeville, PA (US)

Correspondence Address: MUSERLIAN, LUCAS AND MERCANTI, LLP, 600 THIRD AVENUE, NEW YORK, NY, 10016, US

(21) Appl. No.: 10/378,272

(22) Filed: Mar. 3, 2003

Related U.S. Application Data
(60) Provisional application No. 60/361,478, filed on Mar. 4, 2002.

(51) Int. Cl. C03C 17/00; C09D 5/00

(52) U.S. Cl. 523/160; 523/161

(57) ABSTRACT

The present invention is directed to ink compositions which are resistant to agglomeration. The ink compositions include a dispersion containing pigment particles having a particle size of less than about 1 micron, a dispersing resin, a base; and water. Methods of preparing the ink compositions and applying them to various surfaces are also disclosed.

### CROSS-REFERENCE TO RELATED APPLICATIONS

This application claims the benefit of priority from U.S. Provisional Patent Application No. 60/361,478 filed Mar. 4, 2002, the contents of which are incorporated herein by reference.

### BACKGROUND OF THE INVENTION

The ink-jet printing process provides many advantages. It is fast and can be used to print on both porous and non-porous materials. Ink jet printing can be used to print on a variety of materials, e.g. metals, plastic, glass, fabric or paper. It is a non-contact printing method and hence may be used to place printed images on irregular surfaces and fragile materials. There have been many developments in the ink jet process. The continuous printing ink jet process gave way to drop-on demand processes in the 1980's and pigments were added to jet ink in the 1990's. Despite the many advantages of the process, the ink jet process places rigorous requirements on the permissible inks.

In the continuous ink-jet printing process, the ink is formed into a destabilized jet of individual droplets by vibration or pressure applied to ink. The droplets are charged by applying a voltage between the jet and the charged electrode before the droplets are formed. Some of the drops are directed to the target and printed and the remainder filtered, recycled and passed to the ink reservoir for reuse. The re-cycled ink is exposed to oxidation which can produce cross-linking in phenolic resin inks for example. The recycling process also exposes the ink to mechanical, thermal and hydrolytic processes. Other important properties of continuous printing jet inks are viscosity, surface tension and conductivity. Any of these conditions may produce agglomeration of the colorant or the resin binders, making the ink unusable in an ink jet process.

In the drop on demand (DOD) process, drops of ink are produced from an array of nozzles using an ejection mechanism which expels the droplets under pressure from a valve to a position on the substrate. The nozzles are activated at the desired frequency and in the desired order, as by digital data signals, to form the desired image. No ink recovery, charging of ink or deflection of ink droplets is required. Thus, DOD inks need no conductive or polar materials. The lack of continuous flow, however, brings its own requirements, such as maintaining flow through intermittent use at the nozzles and in the capillaries to the nozzle. In both continuous or drop-on-demand processes, the ink must be carefully chosen and controlled.

There are some common requirements for both continuous and DOD inks. The most critical requirement for all jet ink compositions is the particle size of ingredients included therein. Ink jet printing generally does not tolerate particle sizes of greater than about 1 micron. This is due to the small opening size of the nozzles and nozzle feed channels. Continuous printing places even greater demands on particle size, with about 0.3 microns being the upper limit before clogging occurs. In general, size of the nozzle varies inversely with the ability to control the ink jet. This is especially true for continuous processes which must produce controllable droplets from a vibrating nozzle. The second critical requirement of all jet inks is that they minimize particle agglomeration. It is to be noted that agglomeration of either the colorant pigments or the resin/binders of the inks may occur. Either is unacceptable.

The colors used in printing inks generally fall into two categories: dyes and pigments. Dyes are generally soluble and may be easily incorporated into inks, but the printed colors tend to bleed. Pigments are generally insoluble in water, hence particle size and lack of agglomeration become important. Because of the particle size requirements of jet inks, dyes were first incorporated into jet inks for color. As anticipated, however, printing with dyes tends to bleed. This is undesirable for food and food packaging materials, as well as many other uses. Food and food packaging materials, however, present possibly the greatest challenge in print inks. The print on food or food packaging undergo a substantial amount of handling, by wholesalers, store employees and customers. The printed articles may sweat as they are passed into and out of refrigeration. For food in particular, it is most desirable that the printed price code or PLU remain readable at least until the product is brought by the customer to the checkout counter. Thus, bleeding of the printing on the packaging must be avoided for at least this period of handling.

One attempt to create a pigmented ink jet ink is disclosed in U.S. Pat. No. 5,800,601. In the method disclosed therein, the binder is mixed with the dispersant before the colorant is added to the mixture. The premixing of the binder and dispersant is described as permitting the use of pigments rather than dye-stuffs.

Another solution for creating stable dispersions of small particle size pigments is to chemically alter the pigments to be more like dyes. These ink dispersions however still suffer from many of the same problems as inks made with dye colors. Most importantly, they bleed.

For this and other reasons, it would be desirable to produce an ink-jet ink made with pigments rather than dyes which are not prone to agglomeration. While the lack of aqueous solubility of pigments in ink make them desirable for certain aesthetics related to packaging, this property also makes it difficult to convert them into jet inks. The use of pigments in ink compositions requires the artisan to reduce the pigment particles to the proper particle size and develop solvents which prevent agglomeration of the ink composition. They must also allow for the action of a continuous ink film which provides good ink coverage and assists the ink in bonding to the target. The present invention addresses these needs.

### SUMMARY OF THE INVENTION

In one aspect of the invention, there are provided improved ink compositions which resist agglomeration. Preferred ink compositions include a dispersion containing

a) pigment particles having a particle size of less than about 1 micron;

b) a dispersing resin;

c) a base; and

d) water.

The dispersion is also part of an alkaline medium and the binder is preferably an acrylic binder having an acid number of from about 50 to about 300. The pigment particles included in the dispersion are preferably black and may be selected from among channel black, furnace black and mixtures thereof. In certain other preferred aspects of the invention, the ink compositions of the invention also include a dispersant or dispersing resin. Furthermore, the ink compositions preferably include from about 10 to about 40% by weight water.

For purposes of the present invention, the term “alkaline medium” shall be understood to be a medium having a basic pH. The alkaline media of the ink compositions of the present invention, however, preferably has a pH of at least about 8.5 and more preferably at least about 9. The pH is maintained in the ink compositions by including sufficient amounts of bases such as ammonium hydroxide, triethanolamine, diethanolamine or mixtures thereof It will also be understood that while the chip dispersion is described herein as being in an alkaline medium, the ink compositions themselves have an alkaline pH.

In other aspects of the invention there are provided methods of preparing the ink compositions described above. The methods include a) providing a chip dispersion of pigment particles having a particle size of less than about 1 micron; b) placing said chip dispersion in an aqueous, alkaline medium; c) adding a binder to said alkaline medium; and d) mixing the combination of ingredients until a substantially homogeneous mixture is obtained.

A still further aspect of the invention includes a process for printing various characters or designs on food or pharmaceutical items with the above-described jet ink compositions. The process includes projecting a stream of droplets of a jet ink composition described above onto food or pharmaceutical items and controlling the direction of the stream such as with an inkjet nozzle so that the droplets are caused to form the desired printed characters, design, message, etc. on the surface of the items.

For purposes of the present invention, the term “chip dispersion” shall be understood to mean dispersions of pigments of small, uniform particle size prepared using a two roll mill at high temperature and pressure to obtain optimum reduction of the particle size and wetting of the particles. In the present case, small shall be understood to mean less than about 1 micron and “uniform particle size” shall be understood to mean a defined particle size distribution within a stated average.

As a result of the present invention, improved ink compositions useful in inkjet printing processes are provided. The compositions resist agglomeration prior to application and bleeding after being applied to the surface of various materials. Advantageously, the jet inks of the present invention may be diluted with water, if desired, and will remain free of appreciable or significant agglomeration. It is believed that the charge-charge repulsion between pigment particles gives rise to this “stability” in water, and creates stable dispersions of small particle size pigments. In addition, solvent-based inks of chip dispersion particles of pigment may be made. Other and further advantages will be apparent from the description provided below

### DETAILED DESCRIPTION OF THE INVENTION

Broadly stated, the present invention is directed to improved ink compositions. The compositions include a dispersion containing

a) pigment particles having a particle size of less than about 1 micron;

b) a dispersing resin;

c) a base; and

d) water.

The dispersing resin binder which provides the pigment surface wetting and ionic charge repulsion to stabilize the dispersion. The development of an improved inkjet ink composition required solutions to several key problems. Whether continuous or drop-on-demand, the inkjet inks should have an average particle size of less than about 1 micron. In the case of the compositions of the present invention, the insoluble materials included therein, primarily the pigment particles, have an average particle size of from about 0.1 to about 0.5 microns. Preferably, the average particle size of the pigments is between about 0.25 and about 0.35 microns. It has been surprisingly found that when pigment particles of less than about 1 micron are included in ink compositions with a suitable binder in a medium having an alkaline pH, stable ink compositions which resist pigment agglomeration result. The ink compositions preferably have a viscosity of from about 2 to about 20 centipoise (cps). More prefereably, the viscosity is less than about 10 cps.

Suitable binders used in the compositions of the present invention are acrylic binders having an acid number of from about 50 to about 300. Preferably, the dispersing resin is an acrylic binder having an acid number of from about 100 to about 300 and preferably from about 180 to about 220. A non-limiting list of suitable acrylic binders include S C Johnson's styrene acrylic Joncryl 682 or S C Johnson's Joncryl 678 acrylic resin which have acid numbers of 238 and 215, respectively. In addition, the ink formulation can contain acrylic binder emulsions which provide adhesion and other desired functional properties such as S C Johnson's DFC 3030 or S C Johnson's Joncryl 624 acrylic emulsions which have acid numbers of 64 and 50, respectively.

The pigment particles are preferably black, but other pigments such as phthalocyanine or quinacridone may be used. Ink compositions made with black pigments preferably have a pigment density of from about 1.5 to about 1.7 and a reflective optical density of less than about 1.5. Pigment (print) density is defined as in the printing industry as reflective optical density. A good range for black inks is 1.5 to 1.7. Reflective optical density is defined as D=log 1/R, where D is the density and R the reflectance. Each color has its own standard color density requirement for printing. For black inks it is about 1.6, hence the ink compositions of the present invention perform well. Cyan inks need a color density of about 1.45, Magenta about 1.35 and Yellow about 1.0. Suitable black pigment particles can be based on channel black, furnace black and mixtures thereof.

The chip dispersions used in the present invention can be prepared using commercially available materials or purchased from commercial suppliers. For example, black chip dispersions made by Penn Color of Harleysville, Pa. are available as a paste or slurry. These can be further diluted to about 10 cps in alkaline water, propylene glycol or mixtures thereof before being included in the compositions of the invention. The chip particles included in any compositions of the present invention are preferably less than 1 micron in average particle size (sub-micron). Care must be taken when diluting pastes or slurries containing the same to avoid the loss of any resin present which envelops the pigment particles. Thus, solvents and conditions should selected which maintain the basic conditions when diluting, to avoid “undressing” of the pigment particles which causes agglomeration. This issue can usually be avoided by making sure that the medium is maintained at a pH of at least about 8.5 and by avoiding solvents which dissolve the resin present in the slurry or paste.

If commercially available chip dispersions are not used, they can be prepared using techniques well known to those of ordinary skill. For example, the pigments must be ground before use. Examples of grinding processes are horizontal milling and chip dispersion. Following grinding, the small particle size pigment is made into an ink by combining it with the appropriate solvents. In the attempt to form the ink, pigments may easily precipitate or agglomerate. Some chip dispersion processes are described as follows.

Chip Dispersion

One chip dispersion process disperses pigments in resins using a two roll system that under high temperature and pressure melts the resin. When cooled, the resin forms sheets that are brittle and can be broken into small particles. This chip dispersion process therefore has four principal steps:

Step 1: (A pre-mix phase) The pigment is slowly added to a resin containing a volatile plasticizer. The addition takes place in a sealed vessel that is rotated.

Step 2: The addition product of step 1 is place in a two roll mill, using heated rolls and high pressure. The resin/plasticizer mixture melts and forms plastic bands around the rolls, which are repeatedly cut off, turned and re-placed into the nip until the pigment dispersion into the resin/plasticizer is complete.

Step 3: The product of step 2 is then passed through under pressure forming sheets while it cools. At the same time, the volatile plasticizer evaporates leaving behind a brittle sheet of the pigment dispersed in the resin.

Step 4: When the sheets are cooled, they can be broken down into small particles through the use of a high-output cutting mill.

In order to avoid the agglomeration associated with solvent based systems, water-based_chip dispersions were made using S C Johnson's Joncryl -67 (J-67) acrylic resin. It was surprisingly found that chip dispersion of black pigments (including pigment particles and dispersing resin) in J-67 were stable if they were prepared in an aqueous alkaline medium. Ammonium hydroxide was used in the chip dispersion to keep the pH at least about 8.5. Triethanolamine and/or diethaolamine as well as combinations of the foregoing can also be used to maintain the pH. Aqueous chip dispersions were made of channel black as well as furnace black and the resultant chip dispersion were found to have a particle size distribution less than one micron. These chip dispersions could be diluted with water to low viscosities without any agglomeration occurring. The inks made from these dispersions were easily filtered. The filtered ink print densities were above 2 when drawdowns were made with #7 Meyer rod.

Unique ink formulations were made which used J-67 as the chip-dispersing vehicle, preferably modified with Joncryl-624 (J-624) resin. For example, one formula utilized the chip dispersion as well as Joncryl emulsion 624,isopropanol and propylene glycol. This ink had good ink adhesion to a steel can and held up to 2-hour steam sterilization.

While applicant is not bound by theory, it is believed that the stability of the jet ink formulations of the present invention arise from the affinity of resins of this type for the highly aromatic pigment surfaces, such as those found on carbon black, phthalo blue, pigment yellow 180 and quinacridone (magenta color). The resin contains many carboxylic groups. When the pH is rendered alkaline, these carboxylic groups take on a negative charge as the carboxylic anion is still attached to the resin. As a result, all the particles are surrounded with a large number of carboxylic anions having a negative charge. Hence, they have a tendency to repel one another, which tendency acts to prevent agglomeration, making the formulations very stable. The higher the pH, the more stable the medium, and hence, the ink formulation. When the pigment particles are added to a resin, the resin tends to wrap around the particle. When using aromatic resins, maintaining an aqueous alkaline medium imposes an anionic charge of the resin coated particles, causing them to resist agglomeration. The print inks of the present invention display good color strength, good adhesion to the substrate printed, and good resistance to de-lamination or blurring in a two (2) hour steam sterilization process.

In some preferred embodiments of the present invention, the ink compositions include by weight 3-6% pigment particles, 3-12% dispersing resin and 3-15% resin emulsion. The inventive compositions are preferably from about 10 to about 40% by weight water and are kept at an alkaline pH of at least about 8.5 and preferably about 9 or greater with a sufficient amount of a base such as ammonium hydroxide triethanolamine, diethanolamine, mixtures thereof or other suitable reagents know to those of ordinary skill.

The ink compositions may further include coalescent solvents such as diethylene glycol monoethyl ether (DGME) or propylene glycol n-butyl ether in amounts of about 1-5% by weight and/or other (secondary) solvents such as such as isopropanol or n-propanol, making up from about 0 to about 50% by weight of the composition, and additives such as anti-foam additives (Dehydran 4015) from 0 up to about 3% by weight of the composition. A non-limiting list of suitable optional ingredients include other inks, slipping agents, pH control agents, buffers, electrolytes, and volatile plasticizers, etc.

In another aspect of the invention, there is provided a method of preparing the ink compositions described above. The method includes:

a) providing a chip dispersion of pigment particles having a particle size of less than about 1 micron;

b) placing said chip dispersion in an aqueous, alkaline medium;

c) adding a binder to said alkaline medium; and

d) mixing the combination of ingredients until a substantially homogeneous mixture is obtained.

Any optional ingredients such as those mentioned above, e.g. surface active agents, anti-foaming agents, cross-liking agents, electrolytes, buffers, etc. are added and mixed before the final composition is obtained.

Still further aspects of the invention include using the printing compositions described above for printing characters or designs on food or pharmaceutical items. The method includes projecting a stream of droplets of the jet ink compositions described herein onto a food article or a pharmaceutical item such as a compressed table and controlling the direction of the stream so that the droplets are caused to form the desired printed image on the surface of the items. Control of the droplet stream is preferably carried out using an inkjet nozzle and printer apparatus such a Spectra Ink Jet Printer or other high speed commercial inkjet printer. The image can also be made by directing an ink composition through a set of nozzles into droplets and intermittently spraying the droplets on the food or pharmaceutical items until an image is formed.

The ink composition have particular use in ink-jet printing. For continuous printing, the composition must be rendered conductive, and the printing process described as follows: projecting a stream of droplets of the jet ink composition onto a substrate or items to be printed, and controlling the direction of the stream so that the droplets are caused to form the desired printed message on the surface of the items. For drop on demand printing, the process of forming the ink into droplets directed intermittently, at a substrate from an array, or set, of nozzles, to form the image

The pigmented jet inks of the present invention preferably contain:

| Ingredient | % | Function |
|---|---|---|
| Pigment | 3-6% | Colorant |
| Dispersing Resin | 3-12 | Provides pigment wetting and dispersion |
| | | stability |
| Resin Emulsion | 3-15 | Provides good drying and ink adhesion |
| Coalescent solvents | 1-5 | Optimizes ink film properties |
| Other (secondary) | | |
| solvents | 0-50 | Control ink drying and reduce nozzle |
| | | clogging |
| Water | 10-40 | Provides conductivity, dot sharpness and |
| | | solubility for electrolytes |
| Additives (antifoam, | 0-3 | Controls various ink process and end use |
| slip, pH Buffers, | | properties |
| Electrolytes, etc.) | | |

### EXAMPLES

The following examples serve to provide further appreciation of the invention but are not meant in any way to restrict the effective scope of the invention. All ingredients are expressed as being by weight.

The following jet ink formulations were made:

EXAMPLE 1

| Formulation 89-A | Wt (grams) | Percent (%) |
|---|---|---|
| Black Chip dispersion | 50. | 16.6 |
| (16% pigment, 6.1% J-67 resin, | | |
| 72.4% water) | | |
| Deionized water | 150. | 50.0 |
| Isopropanol | 100. | 33.3 |

EXAMPLE 2

| Formulation 89 B | Wt (grams) | Percent (%) |
|---|---|---|
| 89-A (from above) | 200.0 | 91.6 |
| J-624 resin emulsion | 13.0 | 6.0 |
| Propylene glycol methyl ether [PGME] | 2.2. | 1.0 |
| 35% J-67 resin solution in water | 3.0. | 1.4 |

EXAMPLE 3

| Formulation 90-A | Wt (grams) | Percent (%) |
|---|---|---|
| Black chip dispersion | 50.0 | 15.3 |
| (32% pigment, 14.2% J-67 resin, | | |
| 53.8% water) | | |
| Deionized water | 150.0 | 45.9 |
| Isopropanol | 100.0 | 30.7 |
| J-624 resin emulsion | 20.0 | 6.1 |
| PGME | 3.3. | 1.0 |
| 35% J-67 solution in water | 3.3 | 1.0 |

EXAMPLE 4

| Formulation 95-A | Wt (grams) | Percent (%) |
|---|---|---|
| Black chip dispersion | 50.0. | 16.7 |
| (32% channel black, 12.6% J-67, | | |
| 55.4% water) | | |
| Deionized water | 150.0. | 50.0 |
| Ethanol | 100.0. | 33.3 |

EXAMPLE 5

| Formulation 95-B | Wt (grams) | Percent (%) |
|---|---|---|
| 586-95-A | 300.0. | 89.15 |
| J-624 resin emulsion | 20.0. | 5.94 |
| PGME | 3.3. | 0.98 |
| 35% J-67 solution in water | 13.2. | 3.92 |

EXAMPLE 6

| Formulation 87-A | Wt (grams) |
|---|---|
| chip dispersion | 50 |
| Joncryl emulsion 624 | 18.3 |
| Isopropanol | 15 |
| Polypropylene glycol | 15 |
| Water | 201.7 |

EXAMPLE 7

| Formulation 97-A | Wt (grams) | Percent (%) |
|---|---|---|
| Black chip dispersion | 50.0. | 17.41 |
| (32% channel black, 12.6% J-67, | | |
| 55.4% water) | | |
| Deionized water | 100.0. | 34.83 |
| Ethanol | 52.0. | 18.12 |
| Dehydran 4025 (defoamer) | 0.1 | 0.03 |
| 35% J-67 solution in water | 60.0. | 20.90 |
| J-624 resin emulsion | 22.0. | 7.67 |
| PGME | 3.0. | 1.04 |

Each of these formulations was tested to see if agglomeration of the pigment particles would occur. After about 24 hours, about 300 ml of each formulation was passed thru 1.2 A filter and the rate of throughput was measured until the whole volume passes. In every case the volume was passed through in less 5 minutes and there was no detectable residue was found on the filter. This indicates that there was no agglomeration and that the small particle size was maintained.

Many modifications and variations of this invention can be made without departing from its spirit and scope, as will be apparent to those skilled in the art. The specific embodiments described above are offered by way of example only, and the invention is to be limited only by the terms of the appended claims, along with the full scope of equivalents to which such claims are entitled. The various patents and publications mentioned herein are hereby incorporated herein by reference.

We claim:

1. An ink composition comprising a dispersion containing
a) pigment particles having a particle size of less than about 1 micron;
b) a dispersing resin;
c) a base; and
d) water.

2. The ink composition of claim 1, wherein said dispersing resin is an acrylic binder having an acid number of from about 100 to about 300.

3. The ink composition of claim 2, wherein said acrylic binder is selected from the group consisting of S C Johnson Joncryl 682,S C Johnson Joncryl 624 and mixtures thereof.

4. The ink composition of claim 1, wherein said pigment particles are black.

5. The ink composition of claim 4, comprising pigment particles selected from the group consisting of channel black, furnace black, and mixtures thereof.

6. The ink composition of claim 1, wherein the composition has a pigment density of from about 1.5 to about 1.7 and a reflective optical density of less than about 1.5.

7. The ink composition of claim 1, wherein said alkaline medium has a pH of at least about 8.5.

9. The ink composition of claim 1, wherein said alkaline medium has a pH of at least about 9.

10. The ink composition of claim 1, further comprising a dispersant.

11. The ink composition of claim 10, wherein said pigment particles comprise about 3-6% by weight of said composition, said dispersant comprises about 3-12% by weight of said composition, and said binder comprises about 3-15% by weight of said composition.

12. The ink composition of claim 11, further comprising from about 1 to about 5% by weight coalescent solvents, up to about 50% by weight of a secondary solvent, and up to about 3% by weight additives.

13. The ink composition of claim 1, wherein said base is selected from the group consisting of ammonium hydroxide, triethanolamine, diethanolamine and mixtures thereof.

14. The ink composition of claim 1, further comprising from about 10 to about 40% by weight water.

15. An ink composition of claim 12, comprising by weight:
from about 3 to about 6% pigment particles, from about 3 to about 12% dispersant; from about 3 to about 15% binder, from about 1 to about 5% coalescent solvents, from 0 to about 50% secondary solvents, from about 10 to about 40% water, from 0 to about 3% additives and a sufficient amount of ammonium hydroxide to render the pH of said ink composition about 9 or greater.

16 The ink composition of claim 1, further comprising an emulsion binder.

17. The ink composition of claim 16, wherein said emulsion binder is S C Johnson J-DCF 3030 or Joncryl J-624.

18. The ink composition of claim 17, wherein the secondary solvent is polypropylene glycol methyl ether (PGME), isopropanol or mixtures thereof.

19. The ink composition of claim 15, wherein the dispersant is S C Johnson J-67 acrylic resin.

20. The method of preparing an ink composition comprising:
a) providing a chip dispersion of pigment particles having a particle size of less than about 1 micron;
b) placing said chip dispersion in an aqueous, alkaline medium;
c) adding a binder to said alkaline medium; and
d) mixing the combination of ingredients until a substantially homogeneous mixture is obtained.

21. A process of printing on food or pharmaceutical items with a jet ink composition, comprising projecting a stream of droplets of a jet ink composition of claim I onto said food or pharmaceutical items and controlling the direction of the stream so that the droplets are caused to form the desired printed message on the surface of said items.

22. A method of printing an image on a food or pharmaceutical item, comprising directing an ink composition of claim 1 through a set of nozzles into droplets and intermittently spraying said droplets of the food or pharmaceutical items until an image is formed.
